(19) United States
(12) Patent Application Publication
(10) Pub. No.: US 2024/0104454 A1
(43) Pub. Date: Mar. 28, 2024

(54) SYSTEM AND METHOD FOR A DECENTRALIZED FREELANCING PLATFORM

(71) Applicant: Thomas Kou Khang, Sacramento, CA (US)

(72) Inventor: Thomas Kou Khang, Sacramento, CA (US)

(21) Appl. No.: 18/126,895

(22) Filed: Mar. 27, 2023

Related U.S. Application Data
(60) Provisional application No. 63/390,053, filed on Jul. 18, 2022.

(51) Int. Cl. G06Q 10/0631; G06Q 10/1053

(52) U.S. Cl. CPC G06Q 10/063112; G06Q 10/1053

(57) ABSTRACT

The present invention pertains to a system and method for the employment of freelance employees, gig employees, and long-term employees. When creating an account on the app, the employees will fill in the necessary information and with the use of GPS, can find jobs that match their desires. Once completing a job, a rating and payment will be made through the app. When employers create an account, with the use of GPS, they can search for employees who match their needs and can pay the employees through the app. The present invention allows both employers and employees to be rated, giving anonymity to all those who use the app. Through the anonymous nature of the present invention, the democratization of the gig employment through the blockchain is done.

The present application claims priority to Provisional Application Ser. 63/390,053 filed Jul. 18, 2022, the content of which is incorporated by reference.

### BACKGROUND

The present invention is directed to an online freelancing platform.

Online freelancing platforms have become increasingly popular in recent years, providing a convenient way for individuals and businesses to find and hire freelancers for a wide range of tasks. Here's a brief overview of some of the popular platforms:

Upwork: This platform connects businesses and individuals with freelancers in a wide variety of fields, including web development, design, writing, marketing, and more. Freelancers create a profile and bid on projects posted by clients.

Fiverr: This platform is designed for small tasks or projects, with a focus on creative work such as graphic design, writing, and video production. Freelancers create gigs, which are brief service listings, that clients can search and purchase.

TaskRabbit: This platform focuses on local services, such as home repairs, cleaning, and moving assistance. Freelancers sign up to become “Taskers,” and clients can browse and book their services directly.

Angie's List: This platform is similar to TaskRabbit, but with a focus on home services and contractors. Clients can search for and read reviews of local service providers before hiring them.

Uber or Lyft: These ride-sharing platforms connect drivers with passengers in need of a ride. Drivers sign up to become independent contractors, and passengers can use the app to request a ride and pay for it.

These platforms give users the opportunity to be connected to users who need freelance jobs to be done, like building a dresser or receiving a ride to the airport. These platforms allow people to take their individual skill set and make a profit off their skills. However, they have not kept up with the demands of a modern workforce.

There are several issues with existing freelancing platforms that affect both freelancers and clients, including:

High fees: Many freelancing platforms charge high fees to both freelancers and clients, reducing the amount of money that freelancers can earn and increasing the cost to clients.

Competition and low pay: Because many freelancing platforms have a global pool of freelancers, the competition can be intense, leading to lower pay rates and a race to the bottom.

Lack of quality control: Some freelancing platforms don't have adequate measures in place to ensure the quality of the work done by freelancers. This can lead to clients receiving subpar work, and freelancers struggling to compete against lower-quality providers.

Limited communication: Some platforms restrict communication between clients and freelancers, which can lead to misunderstandings and make it difficult to ensure that the work meets the client's needs.

Payment issues: Some platforms have been known to delay payments to freelancers or even withhold payment entirely, causing financial stress for freelancers.

Limited opportunities: Some freelancing platforms are saturated with freelancers, making it difficult for new freelancers to find work and build a client base.

### SUMMARY

The present invention pertains to an Open Meta Market (OMM) system, which is a multi-sided software application that provides a platform for freelancers to find and connect to employers far, near, or around the globe as a cooperative and the opportunities for them to be contacted by companies looking for full or part time employees, all accessible with a touch of a finger. The present invention will also allow anyone to post and price their work as well as when they would like the work to be completed. The present invention will then categorize and produce a class drop-pin from any chores, work, projects, or errands by filtering them through four of the different class databases labeled as: S, A, B, and C classes. These classes inform freelancers of the difficulty, length, and skill needed to complete each job. The employer can then place the gig job drop-pin anywhere on the system mobile map where freelancers can view and plan their own daily, weekly, or monthly schedule and after the job is completed and payment is recognized by both parties, they will be suggested to give a rating for each other. The system can also track and record each freelancer's experience onto a graph and can be viewed in their account portfolio, which is also a resume, building credentials, and trust whereby companies looking for full or part time employees with the right skills can connect with them all through our software application.

Both employees and employers looking for employees will create a profile on the OMM system. The OMM system will contain account details of the employee such as: GPS system, ratings, transaction receipts, confirmation of employment, and NFT portfolios. Long term employees' profiles will also include government documents. Employees will either be paid through banks or crypto wallets and that information will also be in the OMM system.

Employees looking for gig jobs or freelance jobs will be given a map of available jobs through GPS location services. This will allow employees to choose jobs nearby and will allow the employer to also view employees nearby to choose from. From the employer creating a job listing, the gig employment opportunities will be classified into different levels. The classifications are S class (expert level), A class (advanced level), B class (intermediate level), and C class (beginner level). These classifications are made by the OMM system through the employer, not through the employees.

An employer looking for employees will put in what type of employee they are looking for, gig employees, freelance employees, or long term employees. From there, the OMM system will give the employer the necessary information to choose which employee on the system they would like to hire. This will all be done anonymously, only through the skills the employee has. For long term employees, a letter of interest will be sent out to the employee. Once an employee is hired and the job is completed, a payment to the employee will be made and the OMM system will keep track of this payment made either through a bank or crypto wallet. After the payment is made, both the employee and employer will be given a choice to give each other a rating, which will be added to employee and employer profiles to be viewed by future employees and employers.

The OMM system will have access to the Hedera Network which will have access to NFT portfolios, smart contracts, and social tokens. With the Hedera Network, employees will be able to upload any NFT portfolio onto the OMM system. This will show off any previous work the employees have done as experience to be hired by future employers. The NFT portfolios will also give employers the opportunity to search for work that best fits their needs for whatever work they need. Employers also have the opportunity to create job listings for gig employees through the Hedera Network. This allows the Hedera Network to create smart contracts for these specific gig employee jobs. For freelancer and gig employees, any work done through smart contract jobs on the Hedera Network will have GPS tracking to keep track of where the employee is doing work. The Hedera Network will also record the time it takes for a job to be completed, creating a token for the employee. This all helps with the payment of the employee by the employer, which is tracked by the OMM system.

The system also enables freelancers to take advantage of changing job opportunities and payment forms, with the increase of NFTs, leaving a lack of this aspect of work on conventional platforms. The system provides a decentralized opportunity to these users. The freelancing platform gives users the opportunity to be hired anonymously. This leads to the need for an online freelancing platform that allows for the democratization of gig employment, paid for and contracted through the blockchain contract. With the increase of NFTs, employees can easily find job opportunities in these fields. Through the nature of the anonymous hiring process, the present system allows for the democratization of the hiring of the many different types of employees available.

The system provides the advantages of an Uber-like on-demand job platform with reviews on the blockchain and NFT features would have several advantages over traditional freelancing platforms, including:

Increased transparency: By using blockchain technology, all transactions and reviews would be publicly accessible and immutable. This would increase transparency and reduce the risk of fraudulent activity.

Enhanced security: The use of blockchain technology would also enhance security, as all transactions and data would be cryptographically secured, reducing the risk of data breaches.

Trust and reputation: The use of NFTs (Non-Fungible Tokens) would enable freelancers to establish their reputation and trustworthiness on the platform. Clients could use NFTs to verify a freelancer's skills, experience, and past work, giving them confidence in their hiring decisions.

Reduced fees: With the use of blockchain technology, transaction fees would be significantly reduced, benefiting both freelancers and clients. This would enable freelancers to earn more money for their work and reduce the cost of hiring for clients.

Improved user experience: The use of blockchain technology and NFTs would provide a better user experience for both freelancers and clients. The transparency and trust established by the technology would make it easier for freelancers to find work and for clients to find qualified freelancers.

Decentralization: The use of blockchain technology would enable the platform to be decentralized, meaning it would not be owned or controlled by a single entity. This would increase the platform's resilience to external attacks and reduce the risk of censorship.

Overall, the instant job platform with reviews on the blockchain and NFT features has the potential to revolutionize the freelancing industry by increasing transparency, security, trust, and reducing fees. These benefits could attract more freelancers and clients to the platform, creating a more robust and diverse marketplace.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is a view of a context diagram which defines the system boundaries showing inputs and outputs of data to and from the OMM system and each of the Entity.

FIG. 2 is a view of a physical data flow diagram which captures who or what is performing the activities.

FIG. 3 is a view of a logical data flow diagram that captures the activities that occur in the process from each Entity.

FIGS. 4A-E is a view of a System flow chart which is to capture the flow of data through the system and show who is responsible in performing different activities in the system.

FIG. 5 is a photo of the OMM system map.

FIG. 6 is a diagram of how the OMM system uses smart contracts, NFTs, and social tokens from a decentralized network service called Hedera.

FIG. 7 is another diagram of how the OMM system uses Hedera.

FIG. 8 is a view of a Network Diagram showing how different devices communicate with each other as well as the flow of information through that network.

FIG. 9 is a line diagram illustrating a decentralized network.

FIG. 10 is a line diagram illustrating a distributed network.

### DETAILED DESCRIPTION OF THE PREFERRED EMBODIMENT

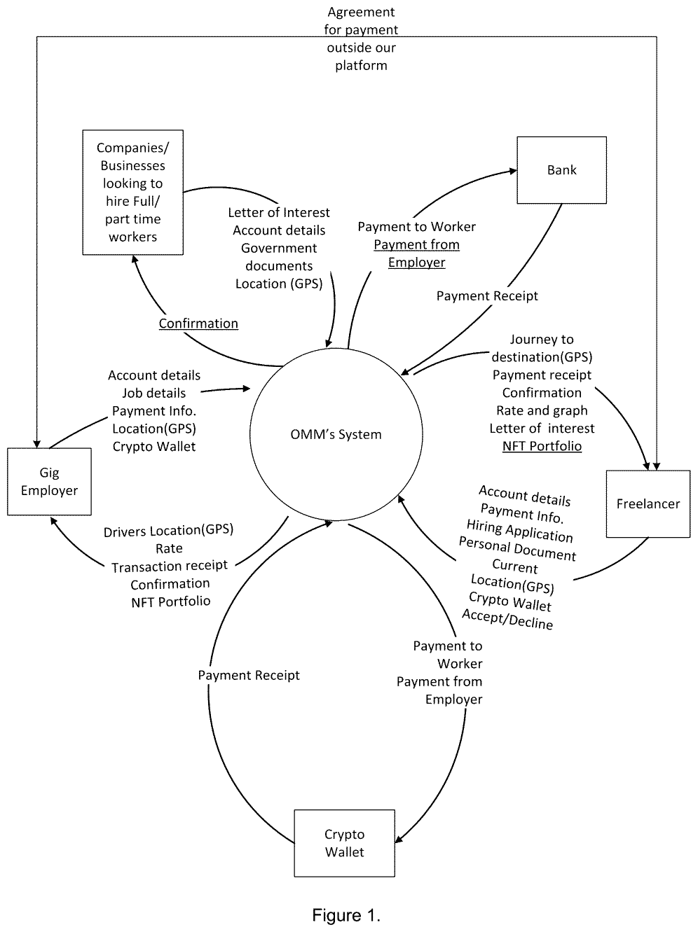

FIG. 1 is a view of a context diagram which defines the system boundaries showing inputs and outputs of data to and from the OMM system and each of the Entity. In accordance with the preferred embodiment of the present invention, the system is comprised of 5 core components: the gig or temporary employer; companies that are looking to hire a long-term employee; banks; freelance contractors; and cryptocurrency wallets. The gig or temporary employer enters account details, job details, payment information, location data and cryptocurrency information into the system of the present invention. The system provides the gig or temporary employer with data such as the freelancer or driver's location (through GPS or geolocation data), the freelancer's rate, transaction receipt, confirmation and an NFT portfolio. Companies that are looking to hire long term employees through the system can enter a letter of interest, account details, government documents and location data (through GPS or geolocation data). The system can provide those companies with confirmations. Banks can be integrated into the system of the present invention by processing payments both to the worker and from the employer, providing the system with payment receipt data. The freelance contractor can enter account details, payment information, hiring applications, personal documents, current location data, cryptocurrency wallet information, and accept or decline job offers through the system. The system provides the freelance contractor with journey to destination log data (through GPS or geolocation data), payment receipts, confirmations, rates, letters of interest, and NFT portfolios. The system can also facilitate cash payment or cold wallet payments to the freelance contractor or employee. The system can also integrate cryptocurrency wallets, wherein the system provides payment to the worker or from the employer using a cryptocurrency wallet, and a confirmation of cryptocurrency payment data is uploaded to the system.

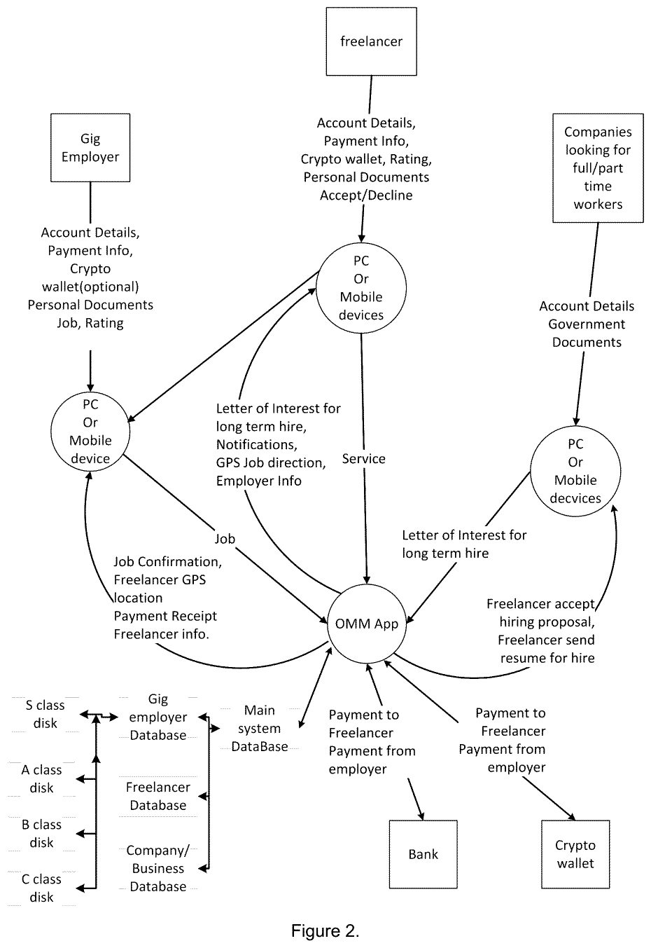

FIG. 2 is a view of a physical data flow diagram which captures who or what is performing the activities. In accordance with the preferred embodiment of the present invention, all activities and information will be input into the OMM app. For the freelancer employee their account details, payment information, crypto wallet, rating, personal documents, and acceptances or declines of offers through the phone and into the OMM app. Their service is then input into the OMM app. Once the OMM app has the information, it will send letters of interest for long term hire, notifications, GPS job directions, and employer information to the phone to be received by the freelancer employee. The OMM app will also have access to the bank and the crypto wallet to complete payment from the employer to the freelancer in whichever payment option that is chosen. For companies looking for long term employees, account details and government documents are input through the computer and a letter of interest to long term employees will be sent to the OMM app, which is sent to the freelancer employees. Once a freelancer employee accepts, confirmation from the OMM app will be sent to the companies looking for long term employees through the computer system. For the gig employer, account details, payment information, the optional crypto wallet, personal documents, job, and ratings are input through a laptop to receive a job through the OMM app. The OMM app will then send back through the laptop, confirmation of the job, freelancer GPS location, and payment receipt. The OMM app's main database will hold the information on the different types of employees and employers, which are freelancers, gig employees, and companies looking for long term hire. The OMM system will define each gig jobs into different classes which are defined as S class, A class, B class, and C class. The S class is an expert level skilled employee, such as mechanical workers, skill I.T. or programming work, skill labor, or projects. The A class is advanced level skills that may require tools. Examples of the A class are mechanical work, hard labor, some quick I.T. repair, travel guide, trainer, or projects. The B class is intermediate skill level for ages 16 and up. Examples of this class include customer services, food delivery, taxi, dog walking, small maintenance, babysitters, or projects. The C class is beginner skill level for ages 10-15+. This class requires little to no skills needed and can be done by underage children in a designated range by a parent or guardian. Examples of this class can include lawn mowing, car washing, small repairs, house cleaning, and dog walking.

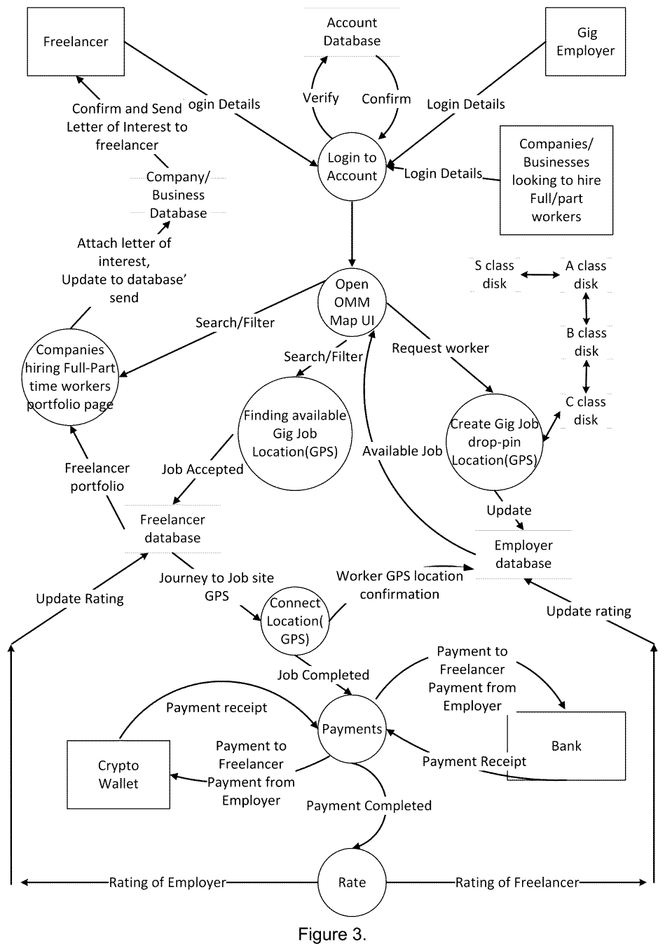

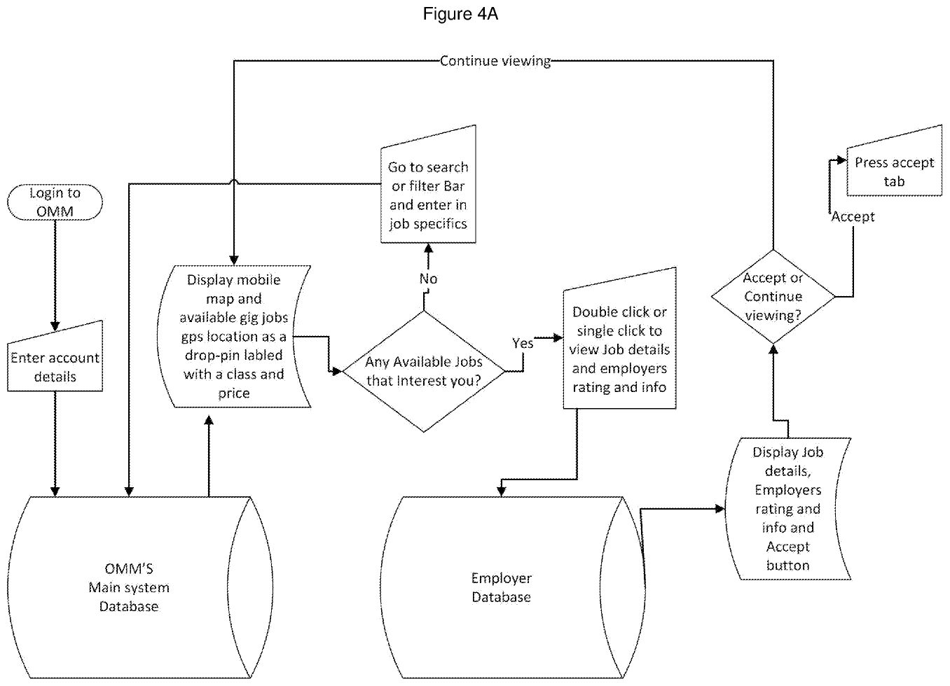

FIG. 3 is a view of a logical data flow diagram that captures the activities that occur in the process from each entity. In accordance with the preferred embodiment of the present invention, the account database holds all the information of all the activities and for those who do the activities. The freelance contractor, gig employer, and companies looking to hire long term employees will input their login details when they login to their account. This will be verified and confirmed by the account database. For companies and businesses looking to hire full or part time employees, they only need to log into the OMM system. There, the company database is only used to store data in terms of who the company that created the company account in the system is and who the company has hired through the OMM system. The company account can find full or part time freelance portfolios of someone they would like to hire and attach a letter of interest to their company's account. This will then be confirmed, and the letter of interest will be sent to the employee. The employee will receive the letter of interest and will receive a rating of the employer.

For the freelancer database, a freelancer will login to their account and view the map which will allow them to find available jobs based on GPS location. Once the job is accepted, the freelancer will be brought to the job site GPS and connect locations. Once a job is completed, payments from the company will be made either to the bank or crypto wallet from employer to freelancer and will be tracked through the OMM system. A payment receipt will be sent and once the payment is completed, a rating of the freelancer will be made by the employer for future employers to review.

For gig employers, once logging into the account, the map will be used to request workers. A gig job drop-pin location (GPS) will be created to find employers nearby. Once the location drop-pin is created, the gig employers will be separated into different classes: S Class (expert level), A Class (advance level), B Class (intermediate level), and C Class (beginner level). From the creation of the gig job drop-pin, an update will be made to the employer contract database to find available jobs. The GPS location will connect gig employees to the employers to complete a job and send payments between gig employers and employees and a rating of the gig employee will be made for future employers to view.

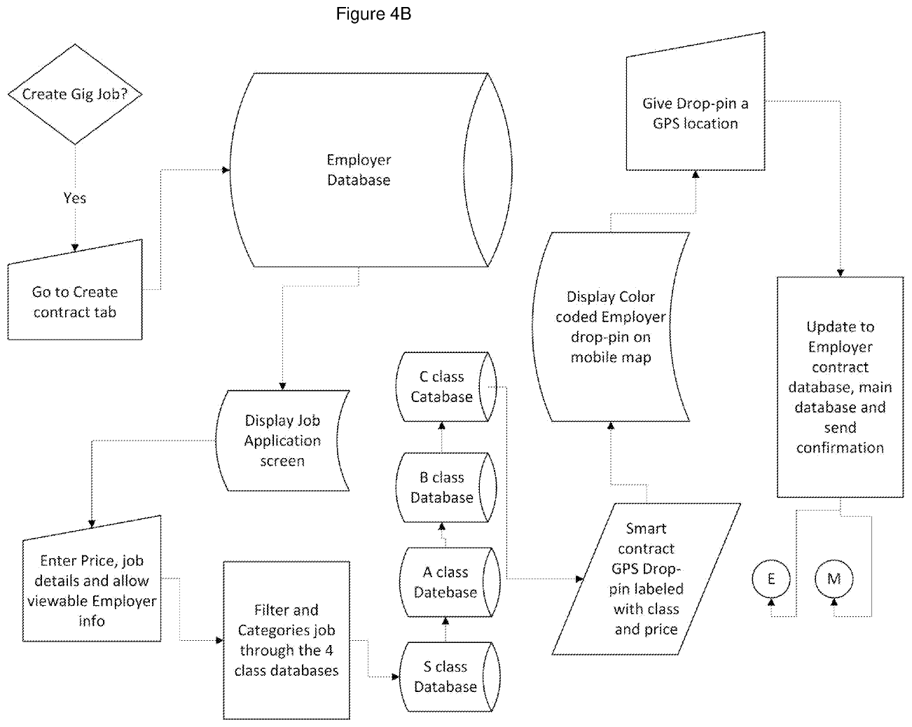

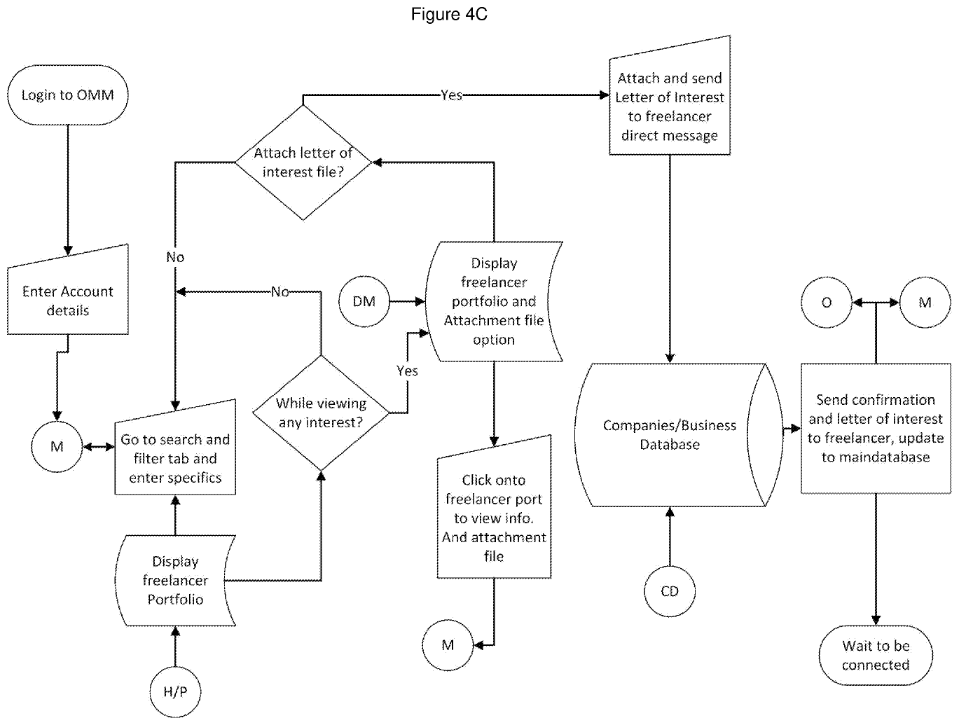

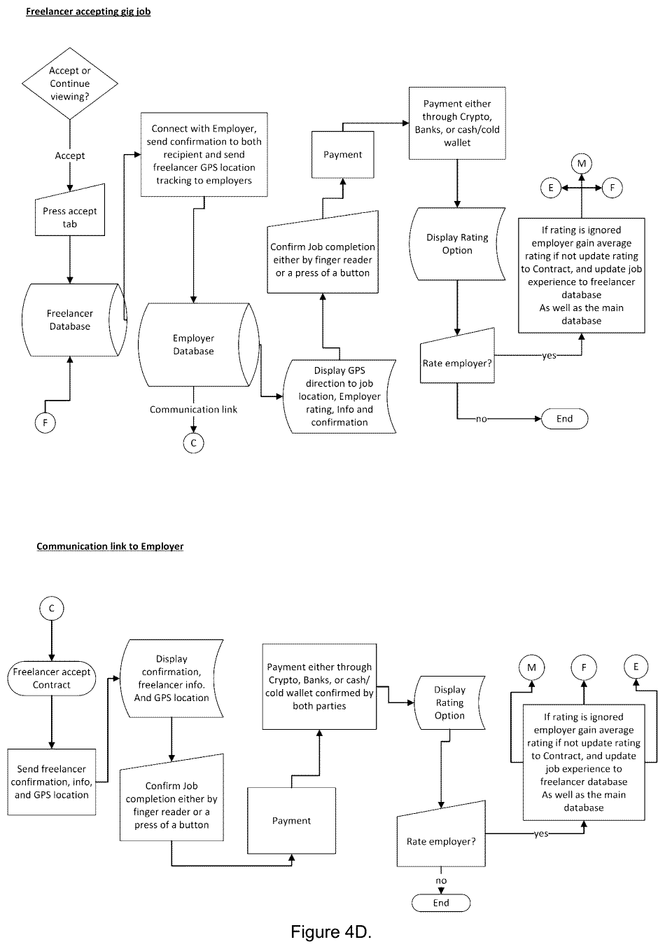

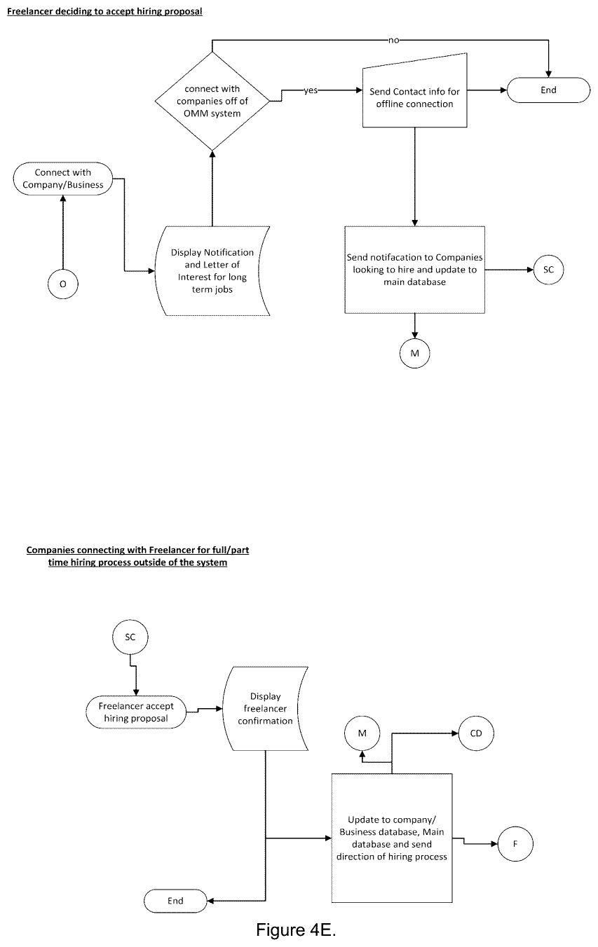

FIGS. 4A-E is a view of a System flow chart which is to capture the flow of data through the system and show who is responsible in performing different activities in the system. FIG. 4A is a view of the login, map, and decision making in the application. A viewable map is the first thing seen after logging in and then a decision can be made. This is the only section in the application that would not be able to recognize any individual until a decision is made.

FIG. 4B continues with when someone decides to create a gig job. This is where the system will recognize you as an employer and take you to a page to create a gig job, Once the gig job description is filled and ready to be created the system will then categorize and label each gig job with the appropriate class. The system will then produce a drop-pin of the job and the employer can then place that drop-pin wherever they would like the gig job to be completed on the system map. The update to the employer, contract, database, and confirmation is then updated on the employer database (E) and main database (M).

FIG. 4C continues with the decision of hiring a full or part time worker is made. This is where the system will recognize you as a company or business looking to hire full or part time and will take you to an on page reference (H/P) (DM) to view all available portfolios. Letter of interests will be sent from the company database (CD) along with communication to freelancers (O) and updates will be made on the main database (M).

FIG. 4D continues with when a decision of accepting a gig job is made. This is where the system will recognize you as a freelancer and create a communication link with the employer that created the gig job.

FIG. 4E continues with when the letter of interest for full or part time hire is sent from a company to a freelancer in the communication link to company (SC). The freelancer then decides whether to accept or not, anything else between the two about the hiring process is made outside the software application. This is all updated on the main database (M), company database (CD), and freelancer database (F).

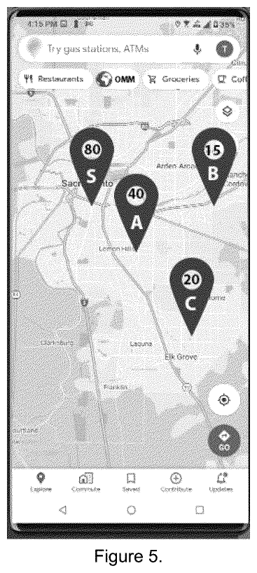

FIG. 5 is a photo of the OMM system map. On the map, you can see the drop-pin label with a class and price of each job. Workers are free to choose and plan their own schedule based on available gig jobs. OMM is a multi-sided application that allows posting of jobs by employers seen as a drop-pin and to give workers a choice to choose which gig job to work.

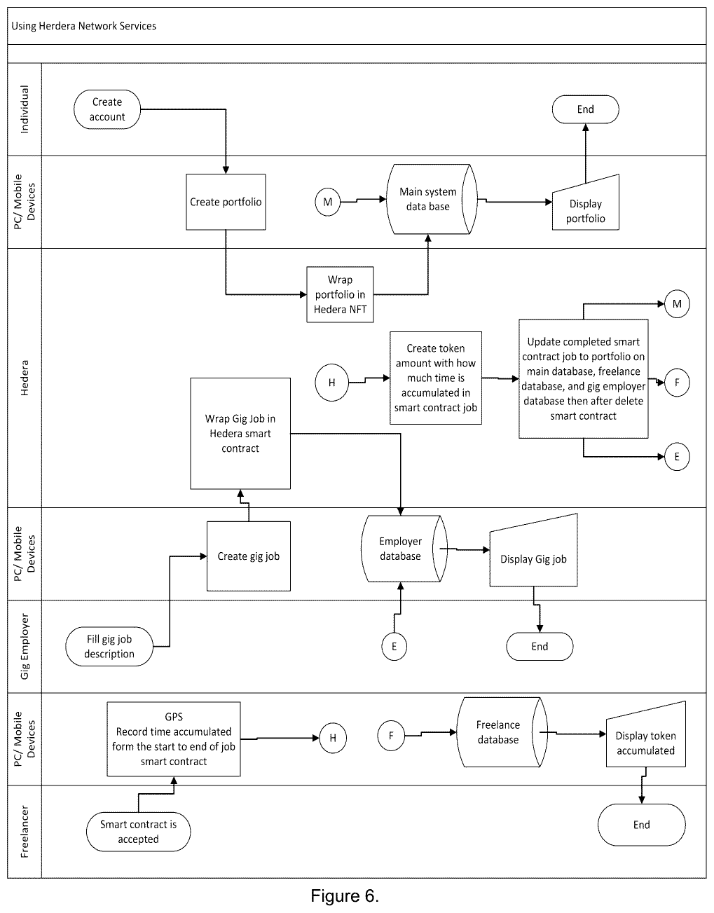

FIG. 6 is a diagram of how the OMM system uses smart contracts, NFTs, and social tokens from a decentralized network service called Hedera. The individual creates an account where they can create a NFT portfolio to be uploaded onto the Hedera NFT database. That is then uploaded into the main database (M) to display the portfolio.

The gig employer will fill a gig job description where they can create gig jobs which will be put in the Hedera smart contract. The Hedera smart contract will be uploaded into the employer database (E) and will display the gig jobs.

The freelancer will accept a smart contract which will have the GPS location of the job and will record the time accumulated from the start to end of the job smart contract, which will be uploaded onto the Hedera database (H). The freelancer database (F) will then display the token accumulated.

On the Hedera database (H), a token will be created with the amount of how much time is accumulated in the smart contract job. This will update a completed smart contract job to the portfolio on the main database (M), freelance database (F), and gig employer database (E) then delete the smart contract after.

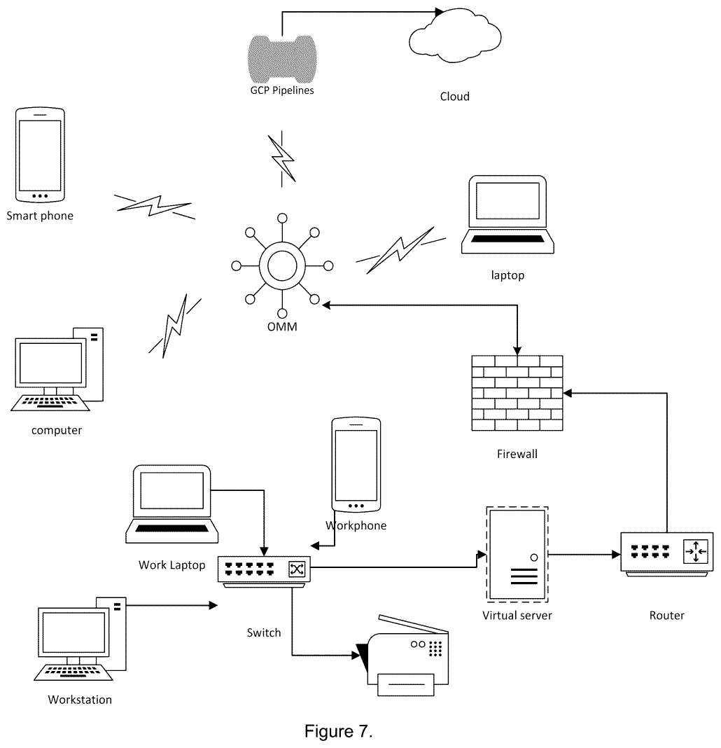

FIG. 7 is a diagram of how the Hedera network works with the OMM system. The Hedera Network services will create NFT portfolios, smart contract gig jobs, and time stamp social tokens which will be sent to the OMM system. The OMM system will then send customer portfolios, freelance time accumulated (time stamp), and employer gig jobs back to the Hedera Network services. A freelancer will receive a Hedera token from the OMM system which in turn will send the GPS tracking and recording of time accumulated back to the OMM system. Customers will receive a Hedera NFT portfolio which then will allow the customers to create an account portfolio, which will be sent to the OMM system. The gig employer will create a gig job in the OMM system which will then send a Hedera smart contract gig job to the gig employer.

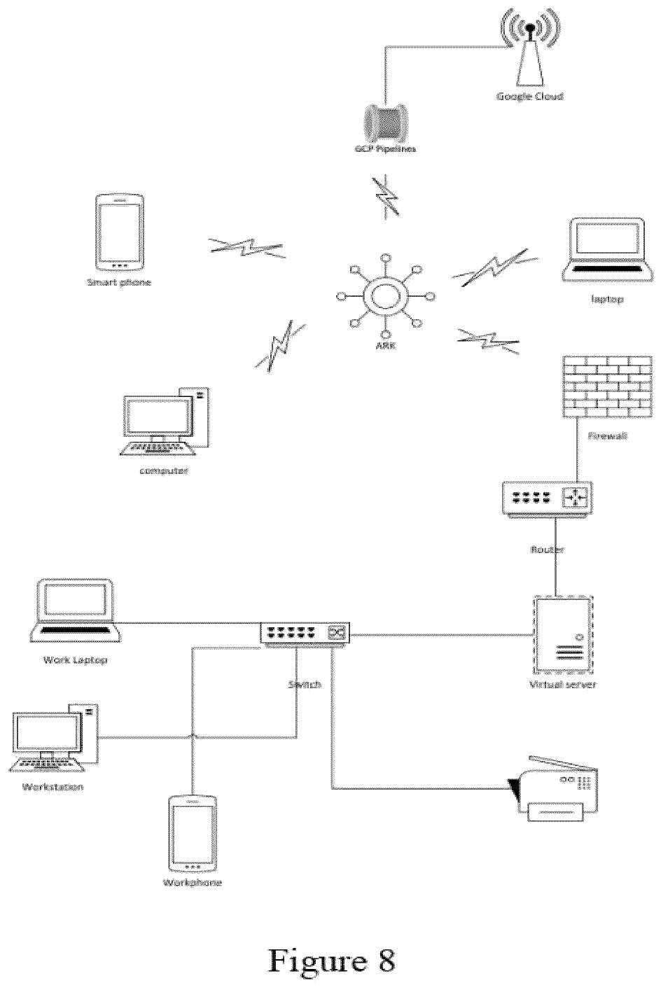

FIG. 8 is a view of a Network Diagram showing how different devices communicate with each other as well as the flow of information through that network. In accordance with the preferred embodiment of the present invention, the OMM system can be used with computers, smartphones, GCP pipelines, laptops, and firewalls. The GCP Pipelines will connect to the Google Cloud to perform operations. The firewall will connect to a router, which connects to a virtual server. The virtual server will connect to the switch. The switch connects to the work laptops, workstation, and work phone to allow the OMM system to be used on all these devices.

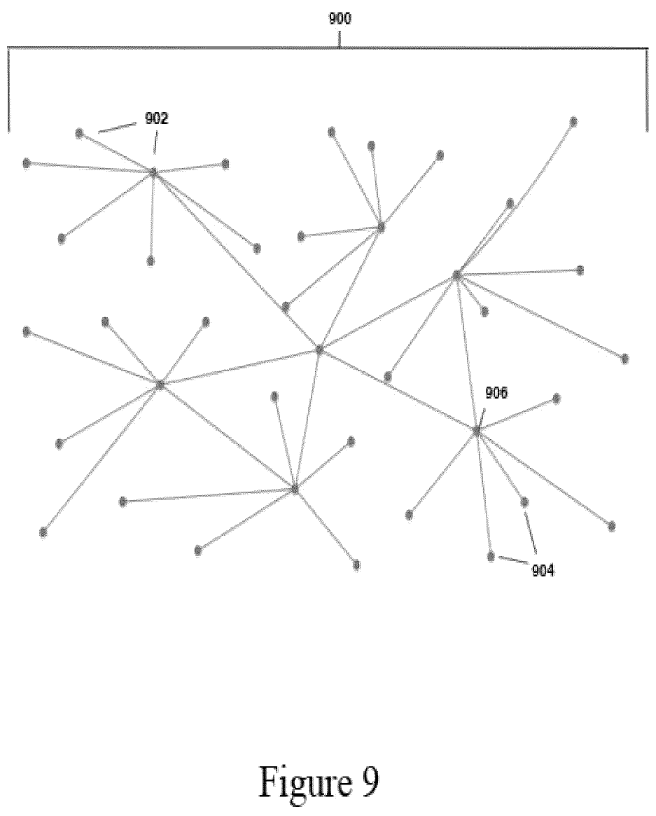

FIG. 9 is a line diagram illustrating a decentralized network. In accordance with the preferred embodiment of the present invention, the specific architecture of the network can be either decentralized or distributed. FIG. 9, generally rorepresented by the numeral 900, provides an illustrative diagram of the decentralized network. FIG. 9 depicts each node with a dot 902 Under this system, each node is connected to at least one other node 904. Only some nodes are connected to more than one node 906.

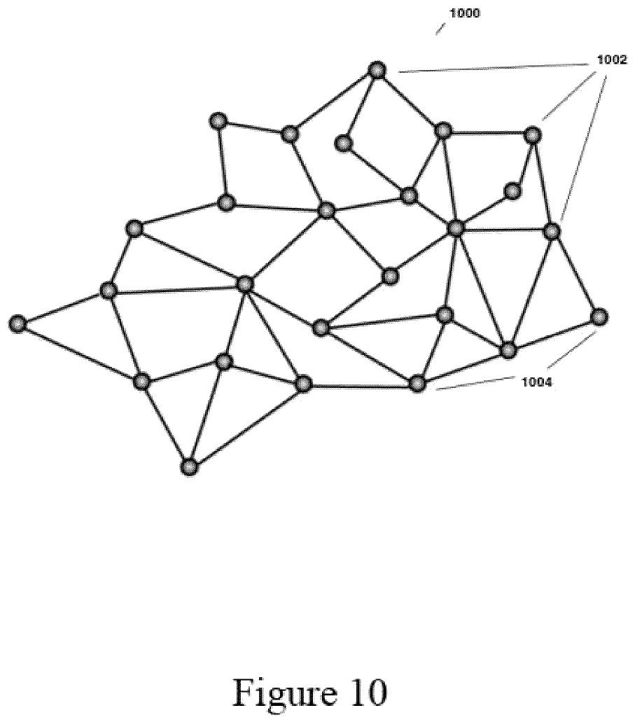

FIG. 10 is a line diagram illustrating a distributed network. For comparison purposes, FIG. 10, which is generally represented by the numeral 1000, illustrates a distributed network. Specifically, the illustration shows the interconnection of each node 1002 in a distributed decentralized network 1000. In accordance with the preferred embodiment of the present invention, each node 1002 in the distributed network 1000 is directly connected to at least two other nodes 1004. This allows each node 1002 to transact with at least one other node 1002 in the network. The present invention can be deployed on a centralized, decentralized, or distributed network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

One embodiment uses the Hedera Network with payment using Bitcoin. The Hedera Network is a decentralized public ledger that aims to provide a fast and secure platform for developing and deploying decentralized applications (DApps), while Bitcoin is a peer-to-peer electronic cash system designed to enable online transactions without the need for a central authority. In one embodiment, the flow is as follows:

A freelancer creates a profile on the instant app which is built as a Hedera Network DApp platform, the freelancer providing details of their skills, experience, and availability.

A client looking for a freelancer browses the DApp platform, searching for freelancers with the required skills and experience. They select a freelancer and agree on the scope of the work and the payment amount.

The client sends Bitcoin to a specified address, which triggers a smart contract on the Hedera Network. The smart contract ensures that the Bitcoin payment is valid and confirms that the freelancer has completed the work to the client's satisfaction.

Once the smart contract confirms that the work is complete, it triggers the release of the payment to the freelancer's Bitcoin wallet.

The freelancer can then withdraw the Bitcoin to a bank account or convert it to a local currency on a cryptocurrency exchange.

This implementation combines the speed and security of the Hedera Network for DApp development with the ease and ubiquity of Bitcoin payments. However, there are some challenges to consider, such as the volatility of Bitcoin's price, the need to ensure that the smart contract functions correctly, and the regulatory requirements around the use of cryptocurrencies. Nonetheless, this implementation can potentially provide a fast and efficient way for freelancers and clients to work together and exchange payments securely.

The present inventors also contemplate that other architectures can be used. For example, Ethereum can be instead of Hedera Network. Ethereum is another decentralized blockchain platform that allows for the development of smart contracts and decentralized applications. In one implementation using Ethereum:

A freelancer creates a profile on an Ethereum-based DApp platform, providing details of their skills, experience, and availability.

A client looking for a freelancer browses the DApp platform, searching for freelancers with the required skills and experience. They select a freelancer and agree on the scope of the work and the payment amount.

The client sends Ether (Ethereum's native cryptocurrency) to a smart contract on the Ethereum network. The smart contract holds the funds in escrow until the freelancer completes the work and the client approves it.

Once the freelancer completes the work, they submit it to the client for approval. If the client is satisfied with the work, they release the funds from the smart contract to the freelancer's Ethereum wallet. If the client is not satisfied, they can request revisions or dispute the work.

The freelancer can then withdraw the Ether to a bank account or convert it to a local currency on a cryptocurrency exchange.

This implementation provides similar benefits to the Hedera Network and Bitcoin implementation, including speed, security, and transparency. However, it uses Ethereum instead of Hedera Network and Bitcoin. Ethereum is a more widely used blockchain platform and has a larger community of developers and users, making it easier to find resources and support. Additionally, the use of Ether eliminates the need for a separate payment system, simplifying the payment process.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A method to matching for a job applicant to a job, comprising:
providing an application (app) to collect an applicant location and an applicant job qualification and saving the collected data on a server;
collecting from an employer an employer name and a job requirement and saving the collected data on a server;
displaying the employer and the job applicant on a map;
at the server, matching the job applicant with the employer based on the applicant location, the job requirement, the applicant job qualification, an employer rating, and a job applicant rating;
creating a smart contract on a blockchain between the matched employer and job application;
upon completion of the job, automatically dispensing a payment from the employer based on the smart contract; and
updating the respecting rating for the employer and the job applicant based on the completed job, wherein the ratings are anonymized on a blockchain.

2. The method of claim 1, comprising determining an applicant location or an employer location with a Global Positioning System (GPS) or a satellite positioning system.

3. The method of claim 1, wherein the employer provides crypto wallet information for payment in the smart contract to be deposited in a job applicant crypto wallet.

4. The method of claim 1, comprising democratizing gig employment with the anonymized ratings on the blockchain.

5. The method of claim 1, comprising creating a non-fungible token (NFT) portfolio with a smart contract and a social token specification, and uploading the smart contract with the social token specification to a decentralized network service.

6. The method of claim 5, comprising displaying the NFT portfolio on the server.

7. The method of claim 1, comprising completing an applicant smart contract with the applicant location and the applicant job qualification and saving the smart contract to a main database.

8. The method of claim 1, comprising completing an employer smart contract with the job requirement and saving the smart contract to an employer database.

9. The method of claim 1, comprising creating a token to store accumulated time in the smart contract job.

10. The method of claim 9, comprising entering into a smart contract the location of the job and a record of time accumulated from start to end of the job into a token, and displaying the token as accumulated.

11. The method of claim 1, comprising rendering the map after logging in, wherein the map hides identity of the employer and the job applicant until a hiring decision is made.

12. The method of claim 11, wherein once the job description created, comprising:
categorizing and labeling each job with a predetermined class;
generating a drop-pin of the job; and
placing the drop-pin by the employer at a performance location where the job is to be completed on the map.

13. The method of claim 1, comprising verifying the employer and thereafter providing employer access to view one or more freelancer portfolios and sending letter of interests from the employer to one or more freelancers.

14. The method of claim 1, comprising verifying the job applicant and providing a communication link with the employer that created the job requirement.

15. The method of claim 1, comprising displaying a drop-pin label with a class and price of each job and allowing the job applicant to choose and plan applicant schedule based on available jobs.

16. The method of claim 1, comprising:
collecting from the employer account details, job details, payment information, location data and cryptocurrency information;
for a long term hire, collecting from the employer a letter of interest, account details, government documents and location data;
providing the employer with job application location, job applicant billing rate, transaction receipt, confirmation and applicant NFT portfolio; and
receiving from the job applicant a current location data, cryptocurrency wallet information and providing the job applicant with a journey to destination log data, payment receipts, confirmations, rates, letters of interest.

17. The method of claim 1, comprising receiving a cryptocurrency wallet, and providing payment to the job applicant using the cryptocurrency wallet, and saving a confirmation of cryptocurrency payment data.

18. The method of claim 1, comprising classifying a job description from one of the following classes: S class, B class and C class, where the S class comprises expert skill, the B class comprises intermediate skill, and the C class comprises beginner skill.

19. A system to transact gig-job matching on a blockchain, comprising:
a mobile device running an application) to collect an applicant location and an applicant job qualification;
a server coupled to the mobile device to save the collected data, the server running code for collecting from an employer an employer name and a job requirement and saving the collected data on the server; displaying the employer and the job applicant on a map; matching the job applicant with the employer based on the applicant location, the job requirement, the applicant job qualification, an employer rating, and a job applicant rating; creating a smart contract on a blockchain between the matched employer and job application; upon completion of the job, automatically dispensing a payment from the employer based on the smart contract; and updating the respecting rating for the employer and the job applicant based on the completed job, wherein the ratings are anonymized on a blockchain.

20. The system of claim 19, comprising:
means for verifying the employer and thereafter providing employer access to view one or more freelancer portfolios and sending letter of interests from the employer to one or more freelancers; and
wherein once the job description created, means for categorizing and labeling each job with a predetermined class; generating a drop-pin of the job; and placing the drop-pin by the employer at a performance location where the job is to be completed on the map.
